(19) United States
(12) Patent Application Publication
(10) Pub. No.: US 2016/0034217 A1
(43) Pub. Date: Feb. 4, 2016

(54) MEMORY CONTROLLER CONFIGURED TO CONTROL DATA SANITIZATION AND MEMORY SYSTEM INCLUDING THE SAME

(71) Applicant: SAMSUNG ELECTRONICS CO., LTD., Suwon-si (KR)

(72) Inventors: JI-SOO KIM, SEONGNAM-SI (KR); MOON-SANG KWON, SEOUL (KR); MYEONG-JIN HAN, YONGIN-SI (KR)

(21) Appl. No.: 14/700,606

(22) Filed: Apr. 30, 2015

Related U.S. Application Data
(60) Provisional application No. 62/031,446, filed on Jul. 31, 2014.

(30) Foreign Application Priority Data
Sep. 26, 2014 (KR) 10-2014-0129521

(51) Int. Cl. G06F 3/06

(52) U.S. Cl. CPC G06F 3/0622; G06F 3/0644; G06F 3/0659; G06F 3/0679

(57) ABSTRACT

Provided is a memory controller configured to control data sanitization. The memory controller includes a sanitization information storing unit configured to store first information or second information in a non-volatile manner, and a control unit configured to store the first information in the sanitization information storing unit when sanitization of data stored in a non-volatile memory has completed in response to a sanitization command of a host and store the second information in the sanitization information storing unit in response to a write command of the host.

### CROSS-REFERENCE TO RELATED APPLICATION

This application claims priority to U.S. Provisional Application No. 62/031,446, filed on Jul. 31, 2014, in the U.S. Patent Office, and Korean Patent Application No. 10-2014-0129521, filed on Sep. 26, 2014, in the Korean Intellectual Property Office, the disclosures of which are incorporated by reference in their entireties herein.

### BACKGROUND

1. Technical Field

The inventive concept relates to a memory controller and a memory system including the same, and more particularly, to a memory controller configured to control data sanitization, and a memory system including the memory controller.

2. Discussion of Related Art

A non-volatile memory refers to a kind of memory capable of retaining stored data even if power supply is interrupted. In recent years, data storages including high-capacity non-volatile memories have been widely employed to store or transfer large amounts of data.

As capacities of data storage devices have gradually increased and as the portability of the data storage devices has improved, there has been a growing likelihood that information within these data storage devices will be accessed by an unauthorized user. In particular, manufacturers, state organizations, and financial institutions need to be able to store information within these storage devices in a secure manner that prevents an unauthorized user from accessing the information.

### SUMMARY

At least one embodiment of the inventive concept provides a method of controlling a memory, a memory controller configured to perform the method, and a memory system including the memory controller. More specifically, the inventive concept provides a method of controlling sanitization of data stored in a non-volatile memory, a memory controller configured to perform the method, and a memory system including the memory controller.

According to an exemplary embodiment of the inventive concept, there is provided a memory controller including: a sanitization information storing unit configured to store first information or second information in a non-volatile manner; and a control unit configured to store the first information in the sanitization information storing unit when sanitization of data stored in a non-volatile memory is completed in response to a sanitization command of a host, and store the second information in the sanitization information storing unit in response to a write command of the host.

The control unit may read information stored in the sanitization information storing unit in response to a check command of the host, and transmit the read information to the host.

The control unit may read information stored in the sanitization information storing unit, and output a control signal based on the read information.

The control unit may be a processor configured to execute a plurality of instructions and access the sanitization information storing unit. The memory controller may further include read-only memory (ROM) that stores the plurality of instructions and is accessed by the processor.

The first information may include information regarding types of the sanitization of the data.

The types of the sanitization of the data may include a Secure Erase or a Crypto Erase.

The second information may include information regarding the size of data stored in the non-volatile memory in response to at least one write command of the host.

According to an exemplary embodiment of the inventive concept, there is provided a memory system including: a non-volatile memory, and a memory controller configured to control the non-volatile memory. The memory controller includes a sanitization information storing unit configured to store first information or second information in a non-volatile manner, and a control unit configured to store the first information in the sanitization information storing unit when sanitization of data stored in the non-volatile memory has completed in response to a sanitization command of the host and store the second information in the sanitization information storing unit in response to a write command of the host.

The control unit may read information stored in the sanitization information storing unit in response to a check command of the host, and transmit the read information to the host.

The control unit may read information stored in the sanitization information storing unit, and output a control signal based on the read information, and the memory system may further include an indicator configured to output a visible signal based on the control signal.

The indicator may include a light-emitting diode (LED) or an electronic ink (e-ink) panel.

The memory system may further include a wireless communication module connected to the sanitization information storing unit. The wireless communication module may output a wireless signal based on information stored in the sanitization information storing unit.

The memory system may further include a sensing unit connected to the sanitization information storing unit and configured to sense an invasive attack against the memory system. The sanitization information storing unit may be re-configured to output a signal corresponding to the second information or third information different from the first information and the second information when the sensing unit senses the invasive attack.

The non-volatile memory may include a plurality of flash memory devices each of which includes a three-dimensional memory array.

The three-dimensional memory array may include a portion that is monolithically formed in one or more physical levels of memory cells having active areas disposed above a silicon substrate.

According to an exemplary embodiment of the inventive concept, there is provided a memory system including a non-volatile memory, a memory controller, and a sensing unit configured to output a message to the memory controller when the sensing unit senses a physical attack against the memory system. The memory controller is configured to sanitize data stored within the non-volatile memory and store information within the memory controller indicating the data has been sanitized, in response to a command received from a host. The memory controller is configured to update the information to indicate the data has not been sanitized in response to receipt of the message.

The sensing unit may be configured to sense whether an attempt to dismantle a case of the memory system has occurred.

The memory controller may be configured to update the information to indicate the data has not been sanitized after receiving a command from the host to write data into the non-volatile memory.

The memory system may further include an electronic ink panel or a light emitting diode to visibly indicate whether the data has been sanitized.

The memory controller may sanitize the data by performing one of a Clear or a Purge action on the non-volatile memory.

### BRIEF DESCRIPTION OF THE DRAWINGS

Exemplary embodiments of the inventive concept will be more clearly understood from the following detailed description taken in conjunction with the accompanying drawings in which:

FIG. 1 is a diagram of a memory system including a memory controller according to an exemplary embodiment of the inventive concept;

FIG. 2 is a diagram of examples of operations of the memory system and a host of FIG. 1 according to an exemplary embodiment of the inventive concept;

FIGS. 3A and 3B are diagrams of examples of a sanitization information storing unit of FIG. 1, according to exemplary embodiments of the inventive concept;

FIG. 4 is a diagram of a memory system including an indicator according to an exemplary embodiment of the inventive concept;

FIG. 5 is a diagram of a memory system including a wireless communication module according to an exemplary embodiment of the inventive concept;

FIG. 6 is a diagram of a memory system including a sensing unit according to an exemplary embodiment of the inventive concept;

FIG. 7 is a diagram of a memory system including a controller according to an exemplary embodiment of the inventive concept;

FIG. 8 is a flowchart illustrating a method of certifying data sanitization according to an exemplary embodiment of the inventive concept;

FIG. 9 is a flowchart illustrating an example of an operation of storing second information shown in FIG. 8, according to an exemplary embodiment of the inventive concept;

FIG. 10 is a flowchart illustrating a method of transmitting information regarding sanitization of data from a memory system to a host according to an exemplary embodiment of the inventive concept;

FIG. 11 is a flowchart illustrating an operation of a control unit of FIG. 4, according to an exemplary embodiment of the inventive concept;

FIG. 12 is a flowchart illustrating an operation of a sensing unit of FIG. 6, according to an exemplary embodiment of the inventive concept;

FIG. 13 is a diagram of a solid-state drive (SSD) according to an exemplary an embodiment of the inventive concept;

FIG. 14 is a diagram of a memory card according to an exemplary embodiment of the inventive concept; and

FIG. 15 is a diagram of a computing system including a non-volatile storage according to an exemplary embodiment of the inventive concept.

### DETAILED DESCRIPTION

The inventive concept will now be described more fully hereinafter with reference to the accompanying drawings, in which exemplary embodiments of the inventive concept are shown. These embodiments are provided so that this disclosure is thorough and complete and fully conveys the scope of the inventive concept to one skilled in the art. Accordingly, while the inventive concept can be modified in various ways and take on various alternative forms, specific embodiments thereof are shown in the drawings and described in detail below as examples. There is no intent to limit the inventive concept to the particular forms disclosed. On the contrary, the inventive concept is to cover all modifications, equivalents, and alternatives falling within the spirit and scope of the disclosure. Like reference numerals refer to like elements throughout. In the drawings, the thicknesses of layers and regions may be exaggerated for clarity. As used herein, the singular forms “a”, “an”, and “the” are intended to include the plural forms as well, unless the context clearly indicates otherwise.

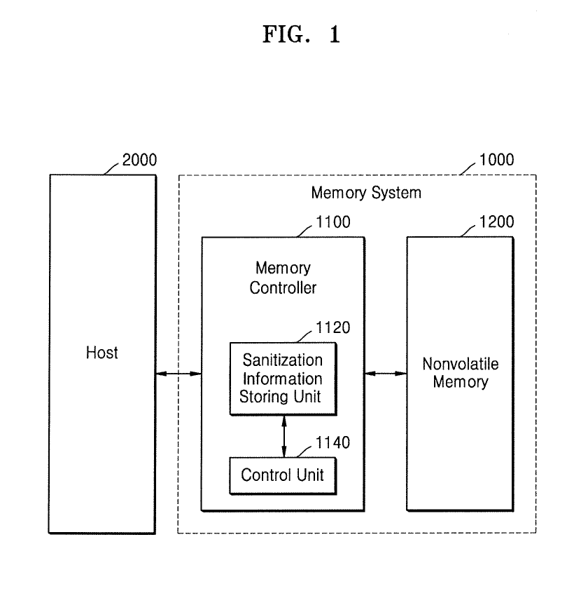

FIG. 1 is a diagram of a memory system 1000 including a memory controller 1100 according to an exemplary embodiment of the inventive concept. The present specification will be described throughout with reference to FIG. 1.

As shown in FIG. 1, the memory system 1000 may communicate with a host 2000 and include a non-volatile memory 1200 and a memory controller 1100 configured to control the non-volatile memory 1200. The host 2000 may transmit commands to the memory system 1000, and the memory system 1000 may perform necessary operations in response to the received commands. The memory system 1000 and the host 2000 may transmit and receive commands and/or data according to a communication interface, for example, advanced technology attachment (ATA), small computer system interface (SCSI), non-volatile memory express (NVMe), embedded multimedia card (eMMCs), or secure digital (SDs), but the communication interface is not limited thereto.

The non-volatile memory 1200 may refer to a memory or memory device capable of retaining stored data even if power supply is interrupted. The non-volatile memory 1200 may be, for example, a NAND flash memory, a vertical NAND (VNAND) flash memory, a NOR flash memory, a resistive random access memory (RRAM), a phase-change RAM (PRAM), a magnetoresistive RAM (MRAM), a ferroelectric RAM (FRAM), a spin transfer torque-RAM (STT-RAM), but is not limited thereto. Also, the non-volatile memory 1200 may be embodied by not only a semiconductor memory device but also by a magnetic disc device. Embodiments of the inventive concept may be applicable not only to a flash memory in which a charge storage layer includes a conductive floating gate, but also to a charge-trap-flash (CTF) device in which a charge storage layer includes an insulating layer. Hereinafter, a case in which the non-volatile memory 1200 is a NAND flash memory will be described for brevity, but it will be understood that the inventive concept is not limited thereto.

In an embodiment of the present inventive concept, the non-volatile memory 1200 may include a three dimensional (3D) memory array. The 3D memory array may be monolithically formed in one or more physical levels of arrays of memory cells having an active area disposed above a silicon substrate and circuitry associated with the operation of those memory cells, where such associated circuitry is above or within such substrate. The term “monolithic” means that layers of each level of the array are directly deposited on the layers of each underlying level of the array.

In an embodiment of the present inventive concept, the 3D memory array may include vertical NAND strings that are vertically oriented such that at least one memory cell is located over another memory cell. The at least one memory cell may include a charge trap layer.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

Data stored in the non-volatile memory 1200 may be deleted in various ways. For example, the data may be deleted by deleting metadata including information stored in a specific region of the non-volatile memory 1200. Also, data to be deleted may be changed into a specific state, for example, a state of erase of a block included in a flash memory. A mode of deleting data stored in the non-volatile memory 1200 may be determined in response to a command received from the host 2000 or determined by the memory controller 1100 configured to control the non-volatile memory 1200.

A unit for restoring deleted data may be used according to a mode of deleting data stored in the non-volatile memory 1200. For example, when a file stored in the memory system 1000 is deleted at a level of a file system of the host 2000, only information required to access data stored in the non-volatile memory 1200 corresponding to the file is deleted instead of deleting the data stored in the non-volatile memory 1200 corresponding to the file. Also, a region of the non-volatile memory 1200, which has been occupied by the stored data, may be allocated for a usable state. In this case, the contents of the deleted file may remain intact in the non-volatile memory 1200 of the memory system 1000. Alternatively, there may be a unit for restoring the contents of the file by restoring the remaining data.

When the memory system 1000 is reused or discarded or for other purposes, it may be necessary to prevent the retrieval of sensitive data, which is stored in the memory system 1000 (i.e., stored in the non-volatile memory 1200 of the memory system 1000). To this end, a communication interface interposed between the memory system 1000 and the host 2000 may support a data sanitization function. For example, in accordance with the communication interface, the host 2000 may transmit a command to instruct data sanitization be performed on the memory system 1000, and the memory controller 1100 included in the memory system 1000 may sanitize data stored in the non-volatile memory 1200 in response to the received command. NIST Special Publication 800-88 guidelines for media sanitization, which was offered by US Department of Defence, classify data sanitization into three forms, namely, ‘Clear’, ‘Purge’, and ‘Destroy.’

As shown in FIG. 1, the memory controller 1100 (which may also be referred to as a controller) of the memory system 1000 may be connected to the non-volatile memory 1200 and the host 2000. The memory controller 1100 may receive commands from the host 2000, and control the non-volatile memory 1200 in response to the received command. For example, the memory controller 1100 may receive a write command from the host 2000, and write data accompanying the received command, into the non-volatile memory 1200. Also, the memory controller 1100 may receive a data sanitization command from the host 2000, control the non-volatile memory 1200 in response to the received command, and sanitize data stored in the non-volatile memory 1200.

It may take a relatively long time to sanitize the data stored in the non-volatile memory 1200. For example, to prevent restoration of the data stored in the non-volatile memory 1200, the memory controller 1100 may overwrite arbitrary data in response to the data sanitization command received from the host 2000. Thus, as the amount of data to be sanitized increases, the time taken for the memory controller 1100 to finish sanitizing the data may increase.

As shown in FIG. 1, the memory controller 1100 may include a sanitization information storing unit 1120 and a control unit 1140. The control unit 1140 may control operations of the memory controller 1100, for example, operations of writing, reading, or sanitizing data, and accessing the sanitization information storing unit 1120. The sanitization information storing unit 1120 may store information regarding sanitization of data. In an exemplary embodiment, the control unit 1140 is a processor.

According to an exemplary embodiment of the inventive concept, the sanitization information storing unit 1120 stores first information or second information. The information storing unit 1120 may store the first information or the second information in a non-volatile manner. In other words, the information storing unit 1120 may retain the first information or the second information even if power supply is interrupted. For example, the first information or the second information may be stored in a non-volatile memory within the information storing unit 1120. When sanitization of data stored in the non-volatile memory 1200 has completed in response to a sanitization command of the host 2000, the control unit 1140 stores the first information in the sanitization information storing unit 1120. Also, when data is written into the non-volatile memory 1200 in response to the write command of the host 2000, the control unit 1140 stores the second information into the sanitization information storing unit 1120.

According to an exemplary embodiment of the inventive concept, the non-volatile memory 1200 stores first information or second information. The non-volatile memory 1200 may store the first information or the second information in a non-volatile manner. In other words, the non-volatile memory 1200 may retain the first information or the second information even if power supply is interrupted. For example, the first information or the second information may be stored in a predetermined region of the non-volatile memory 1200. When sanitization of data stored in the non-volatile memory 1200 has completed in response to a sanitization command of the host 2000, the control unit 1140 may store the first information or the second information in the predetermined region of the non-volatile memory 1200. Also, when data is written into the non-volatile memory 1200 in response to the write command of the host 2000, the control unit 1140 stores the second information in the predetermined region of the non-volatile memory 1200.

In a method of ascertaining whether data stored in the non-volatile memory 1200 is sanitized according to an exemplary embodiment, the host 2000 reads data stored in the non-volatile memory 1200 by directly accessing the non-volatile memory 1200, and then confirms the read data. However, as the capacity of the non-volatile memory 1200 increases, more time may be taken to read the entire data stored in the non-volatile memory 1200. Also, as described above, it may take a long time to sanitize the data stored in the non-volatile memory 1200 again instead of reading the data stored in the non-volatile memory 1200.

In an exemplary embodiment, the sanitization information storing unit 1120 stores the first information and stores a state in which the data stored in the non-volatile memory 1200 included in the memory system 1000 is sanitized. In an exemplary embodiment, the sanitization information storing unit 1120 also stores the second information and stores a state in which the non-volatile memory 1200 exits from a sanitization state. As described below, the memory system 1000 may transmit a state of the non-volatile memory 1200 included in the memory system 1000 to a user based on the information stored in the sanitization information storing unit 1120, so that the user may comprehend the state of the memory system 1000.

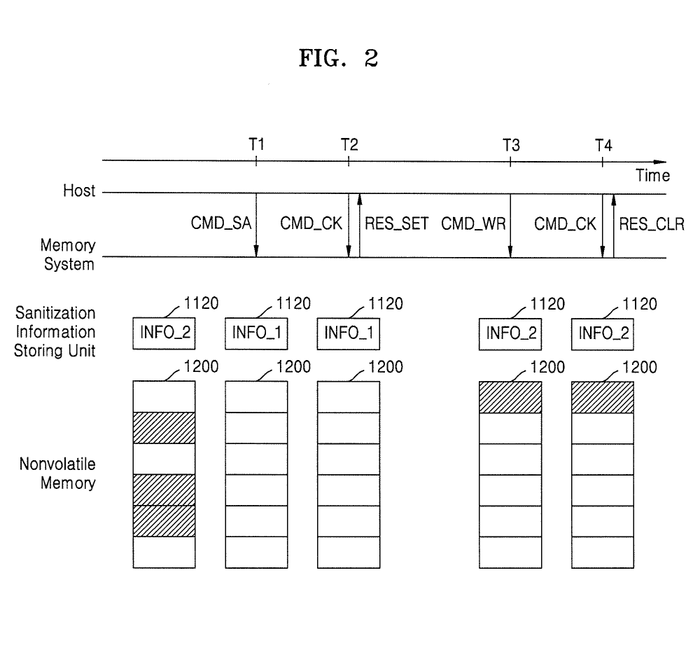

FIG. 2 is a diagram of examples of operations of the memory system 1000 and the host 2000 of FIG. 1, according to an exemplary embodiment of the inventive concept. In FIG. 2, an arrow (from left to right) indicates a direction in which time elapses, and striped portions of a non-volatile memory 1200 denote regions in which written data is stored in response to a write command received from the host 2000, and non-striped portions thereof denote sanitized regions.

According to an exemplary embodiment of the inventive concept, the control unit 1140 of FIG. 1 accesses the sanitization information storing unit 1120 and stores information in the sanitization information storing unit 1120 or reads information stored in the sanitization information storing unit 1120. The sanitization information storing unit 1120 may retain the information even if power supply is interrupted. In an exemplary embodiment, the sanitization information storing unit 1120 includes a non-volatile memory to store information. In an exemplary embodiment, the control unit 1140 accesses the non-volatile memory 1200 and stores information in a predetermined region of the non-volatile memory 1200 or reads information stored in the predetermined region of the non-volatile memory 1200. The information stored in the predetermined region of the non-volatile memory 1200 may be retained even if power supply is interrupted. Also, the control unit 1140 may read the information stored in the sanitization information storing unit 1120 in response to a check command CMD_CK, and transmit the read information or data based on the read information to the host 2000. For example, the check command CMD_CK may be an identification command supported by the communication interface disposed between the host 2000 and the memory system 1000. Thus, the host 2000 may ascertain a state of the memory system 1000, that is, whether the non-volatile memory 1200 is in the sanitization state.

As shown in FIG. 2, before a time point T1, the non-volatile memory 1200 stores written data in response to a write command received from the host 2000, and the sanitization information storing unit 1120 stores second information INFO_{—}2. That is, the second information INFO_{—}2 stored in the sanitization information storing unit 1120 may indicate that the non-volatile memory 1200 is not in the sanitization state.

As shown in FIG. 2, at the time point T1, the host 2000 transmits a data sanitization command CMD_SA to the memory system 1000. The memory controller 1100 of the memory system 1000 sanitizes data stored in the non-volatile memory 1200 under the control of the control unit 1140 in response to the received data sanitization command CMD_SA. When the sanitization of data has completed, the control unit 1140 stores the first information INFO_{—}1 into the sanitization information storing unit 1120 as shown in FIG. 2.

As shown in FIG. 2, at a time point T2, the host 2000 transmits a check command CMD_CK to the memory system 1000. The control unit 1140 included in the memory controller 1100 reads information (i.e., the first information INFO_{—}1) stored in the sanitization information storing unit 1120 in response to the received check command CMD_CK, and transmits a response RES_SET including the read first information INFO_{—}1 or data based on the first information INFO_{—}1 to the host 2000. The response RES_SET transmitted by the control unit 1140 in response to the check command CMD_CK received from the host 2000 at the time point T2 may include information indicating that the non-volatile memory 1200 is in the sanitization state, for example, data in which a specific bit (or flag) is ‘SET.’ For example, in response to the check command CMD_CK, the control unit 1140 may send a computer message to the host 2000 including a flag having a first value that indicates the non-volatile memory 1200 has been sanitized.

As shown in FIG. 2, at a time point T3, the host 2000 transmits a write command CMD_WR to the memory system 1000. The memory controller 1100 stores data accompanying the write command CMD_WR in a specific region of the non-volatile memory 1200 based on an address accompanying the write command CMD_WR, in response to the received write command CMD_WR. The control unit 1140 receives the write command CMD_WR, and stores the second information INFO_{—}2 into the sanitization information storing unit 1120 as shown in FIG. 2.

As shown in FIG. 2, at a time point T4, the host 2000 transmits the check command CMD_CK to the memory system 1000. The control unit 1140 reads information (i.e., the second information INFO_{—}2) stored in the sanitization information storing unit 1120, and transmits a response RES_CLR including the read second information INFO_{—}2 or data based on the second information INFO_{—}2 to the host 2000 in response to the received check command CMD_CK. The response RES_CLR transmitted by the control unit 1140 in response to the check command CMD_CK received from the host 2000 may include information indicating that the non-volatile memory 1200 has exited from the sanitization state in response to a write command issued after the sanitization state, for example, the write command CMD WR issued at the time point T3. For example, the response RES_CLR transmitted by the control unit 1140 in response to the check command CMD_CK received from the host 2000 may include data in which a specific (or flag) is ‘CLEAR.’ For example, if the non-volatile memory 1200 is written once after it has been sanitized; it can be presumed to be in a non-sanitized state. For example, in response to the check command CMD_CK, the control unit 1140 may send a computer message to the host 2000 including a flag having a second value that indicates the non-volatile memory 1200 is no longer sanitized or is not sanitized.

As in the example shown in FIG. 2, the host 2000 may transmit the check command CMD_CK and comprehend whether the non-volatile memory 1200 of the memory system 1000 is in a sanitization state (e.g., is sanitized, is no longer sanitized, or has not been sanitized). While FIG. 2 illustrates the same host 2000 at the time points T1 to T4, the memory system 1000 may communicate with different hosts 2000 at the respective time points. For example, the host 2000, which transmits the check command CMD_CK to ascertain whether the non-volatile memory 1200 is in the sanitization state, may be an exclusive-use terminal disposed at an entrance of a security area. For example, a first host can transmit a command CMD_SA to sanitize the non-volatile memory 1200, and then a second different host can transmit a command CMD_CK to determine whether the non-volatile memory 1200 has been sanitized.

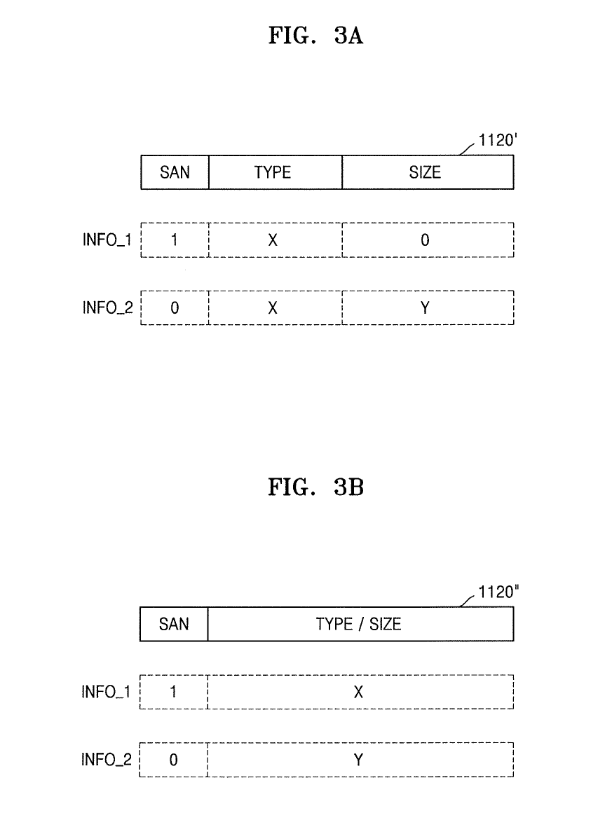

FIGS. 3A and 313 are diagrams of examples of the sanitization information storing unit 1120 of FIG. 1, according to exemplary embodiments of the inventive concept. As described above, the sanitization information storing unit 1120 according to an exemplary embodiment of the inventive concept store first information INFO_{—}1 or second information INFO_{—}2 by using the control unit 1140. The first information INFO_{—}1 may indicate that the non-volatile memory 1200 is in a sanitization state, and the second information INFO_{—}2 may indicate that the non-volatile memory 1200 has exited from the sanitization state (e.g., is no longer sanitized or has not been sanitized). While FIGS. 3A and 3B illustrate examples of the sanitization information storing unit 1120, the sanitization information storing unit 1120 is not limited thereto.

According to an exemplary embodiment of the inventive concept, the first information INFO_{—}1 includes information regarding a type of sanitization of data. As described above, sanitization of data may be of various types according to a sanitization level or according to a mode of achieving sanitization. For example, the first information INFO_{—}1 may include information regarding ‘Clear’ and ‘Purge’ of NIST SP 800-88, or include information indicating a mode or type of sanitization (e.g., a Secure Erase and a Crypto Erase) corresponding to ‘Purge’. In an exemplary embodiment, if the first information INFO_{—}1 indicates a Clear has been performed, then the sanitizing has applied logical techniques in all user-addressable storage locations for protection against simple non-invasive data recovery techniques. For example, these logical techniques may include rewriting (overwriting) one or more parts of the data being sanitized with a new value. In an exemplary embodiment, if the first information INFO_{—}1 indicates a Purge has been performed, then the sanitizing has applied physical or logical techniques that renders target data recovery infeasible using state of the art laboratory techniques. In an exemplary embodiment, if the first information INFO_{—}1 indicates a Destroy has been performed, then the sanitizing has rendered target data recovery infeasible using state of the art laboratory techniques and results in the subsequent inability to use the media for storage of data. The Secure Erase refers to sanitization of data stored in the non-volatile memory 1200, and may be embodied using a specific method according to the type or kind of the memory system 1000. The Crypto Erase may delete a crypto key and preclude decryption of data stored in the non-volatile memory 1200 when the memory system 1000 provides an encryption function, that is, a function of encrypting data and storing the encrypted data in the non-volatile memory 1200.

According to an exemplary embodiment of the inventive concept, the second information INFO_{—}2 includes information regarding the amount of data stored in the non-volatile memory 1200 in response to a write command received from the host 2000. For example, the second information INFO_{—}2 may include information indicating an absolute amount of data written into the non-volatile memory 1200, or include information indicating a ratio of the size of written data to the total size of the non-volatile memory 1200.

In the example shown in FIG. 3A, a sanitization information storing unit 1120′ is classified into three regions, namely, regions ‘SAN,’ ‘TYPE,’ and ‘SIZE.’ The region ‘SAN’ indicates whether the non-volatile memory 1200 is in a sanitization state, the region ‘TYPE’ indicates the information regarding a type of data sanitization, and the region ‘SIZE’ indicates information regarding the size of data written into the non-volatile memory 1200.

According to an exemplary embodiment of the inventive concept, in the region ‘SAN,’ the first information INFO_{—}1 may include a value ‘1,’ and the second information INFO_{—}2 may include a value ‘0.’ Based on a value corresponding to the region ‘SAN,’ the control unit 1140 and the host 2000 may identify the first information INFO_{—}1 or the second information INFO_{—}2. Thus, the control unit 1140 and the host 2000 may ascertain whether the non-volatile memory 1200 is in a sanitization state.

According to an exemplary embodiment of the inventive concept, the first information INFO_{—}1 may include a value ‘X’ in the region ‘TYPE.’ As described above, the value ‘X’ may include the information regarding the type of data sanitization that is performed in the memory system 1000. Meanwhile, FIG. 3A illustrates an example in which the second information INFO₂ includes the value ‘X’ in the region ‘TYPE’ like the first information INFO_{—}1, but the inventive concept is not limited thereto, and the second information INFO_{—}2 may have a predetermined value in the region ‘TYPE.’

According to an exemplary embodiment of the inventive concept, the second information INFO_{—}2 may have a value ‘Y’ in the region ‘SIZE.’ As described above, the value ‘Y’ may indicate the size of data written in the non-volatile memory 1200. Meanwhile, FIG. 3A illustrates an example in which the first information INFO_{—}1 has a value ‘0’ in the region ‘SIZE,’ but the inventive concept is not limited thereto, and the first information INFO_{—}1 may include a predetermined value or include the value ‘Y’ of the second information INFO_{—}2, which is stored in the sanitization information storing unit 1120 before a sanitization operation is started.

In the example shown in FIG. 3B, a sanitization information storing unit 1120″ is classified into two regions, namely, regions ‘SAN’ and ‘TYPE/SIZE.’ As shown in FIG. 3A, the region ‘SAN’ may indicate whether the non-volatile memory 1200 is in a sanitization state, and the region ‘TYPE/SIZE’ may indicate information regarding a type of data sanitization or information regarding the size of data written in the non-volatile memory 1200 depending on the first information INFO_{—}1 or the second information INFO_{—}2.

According to an exemplary embodiment of the inventive concept, the first information INFO_{—}1 indicating that the non-volatile memory 1200 is in a sanitization state may include a value ‘X,’ which may indicate the information regarding the type of data sanitization performed in the memory system 1000, in the region ‘TYPE/SIZE.’ Also, the second information INFO_{—}2 indicating that the non-volatile memory 1200 has exited from the sanitization state may include a value ‘Y,’ which may indicate the information regarding the size of data written into the non-volatile memory 1200, in the region ‘TYPE/SIZE.’

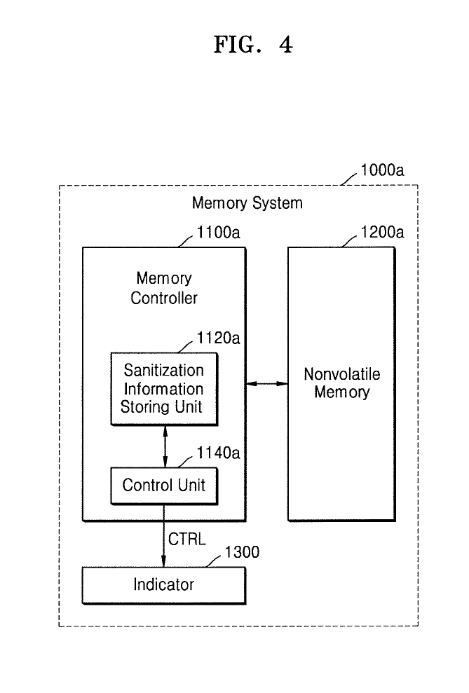

FIG. 4 is a diagram of a memory system 1000a including an indicator 1300 according to an exemplary embodiment of the inventive concept. Similar to the memory system 1000 of FIG. 1, the memory system 1000a includes a memory controller 1100a and a non-volatile memory 1200a. The memory controller 1100a may control the non-volatile memory 1200a and include a sanitization information storing unit 1120a and a control unit 1140a.

According to an exemplary embodiment of the inventive concept, the control unit 1140a outputs a control signal CTRL based on information stored in the sanitization information storing unit 1120a. The control signal CTRL output by the control unit 1140a may be transmitted to another component included in the memory system 1000a, and the component, which has received the control signal CTRL, may inform devices outside of the memory system 1000a of a state of the memory system 1000a, that is, whether the non-volatile memory 1200a is in a sanitization state. For example, as shown in FIG. 4, the memory system 1000a may include the indicator 1300. The indicator 1300 may output a visible signal outside of the memory system 1000a in response to the control signal CTRL output by the control unit 1140a of the memory controller 1100a. For example, the indicator 1300 may include at least one light-emitting diode (LED) or an electronic ink (e-ink) panel. The indicator 1300 may output a visible signal indicating different characteristics in response to the control signal

CTRL, or selectively output the visible signal. For example, the indicator 1300 could turn on a first LED of a first color to indicate the memory 1200a has been sanitized, and turn off the first LED and turn on a second LED of second other color to indicate the memory 1200a has exited the sanitized state. For example, the indicator 1300 could display a certain symbol or graphic on the e-ink panel to indicate the memory 1200a has been sanitized and display a different symbol or graphic on the e-ink panel to indicate the memory 1200a has exited the sanitized state.

According to an exemplary embodiment of the inventive concept, the memory system 1000 includes an internal power source, and the indicator 1300, such as an LED, outputs a visible signal using the internal power source. Examples of the internal power source include a battery. The battery may be rechargeable. Furthermore, according to an exemplary embodiment of the inventive concept, the memory system 1000 does not include the internal power source. In this case, when the indicator 1300 is connected to the host 2000 and receives power from the host 2000, the indicator 1300 may output a visible signal. In particular, since e-ink is capable of retaining an indication state (e.g., displayed graphics representative of a sanitized state) even if supplied power is interrupted, the indicator 1300 including an e-ink panel according to an exemplary embodiment of the inventive concept may be connected to the host 2000 and output a visible signal in response to the control signal CTRL of the control unit 1140. Even if the memory system 1000 is separated from the host 2000, the indicator 1300 may retain the visible signal.

Although FIG. 4 illustrates a case in which the indicator 1300 is connected to the control unit 1140a and receives the control signal CTRL, the inventive concept is not limited thereto. That is, according to an exemplary embodiment of the inventive concept, the indicator 1300 may be connected to the sanitization information storing unit 1120a, and receive a signal output by the sanitization information storing unit 1120a based on stored information (i.e., first information or second information). The indicator 1300 may output a visible signal outside of the memory system 1000a in response to the signal received from the sanitization information storing unit 1120a.

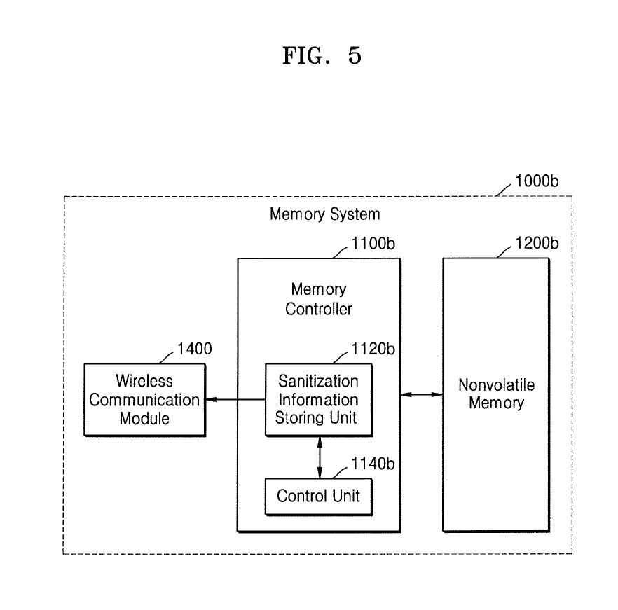

FIG. 5 is a diagram of a memory system 1000b including a wireless communication module 1400 according to an exemplary embodiment of the inventive concept.

Similar to the memory system 1000 of FIG. 1, the memory system 1000b includes a memory controller 1100b and a non-volatile memory 1200b. The memory controller 1100b may control a non-volatile memory 1200b, and include a sanitization information storing unit 1120b and a control unit 1140b.

According to an exemplary embodiment of the inventive concept, the sanitization information storing unit 1120b outputs a signal based on stored information (i.e., first information or second information). The signal output by the sanitization information storing unit 1120b may be transmitted to another component included in the memory system 1000b, and the component, which has received the signal output by the sanitization information storing unit 1120b, may inform devices outside of the memory system 1000b of whether the non-volatile memory 1200b is in a sanitization state. For example, as shown in FIG. 5, the memory system 1000b may include the wireless communication module 1400. The wireless communication module 1400 may transmit data to a wireless communication device disposed outside the memory system 1000b by using a wireless signal, in response to the signal output by the sanitization information storing unit 1120b. For example, the wireless communication module 1400 may include a radio-frequency (RF) module, and transmit wireless signals having different values to an RF terminal disposed outside the memory system 1000b, according to the signal output by the sanitization information storing unit 1120b. For example, a first one of the values may indicate that the memory 1200b has been sanitized and a second other one of the values may indicate the memory 1200b has exited the sanitized state.

Although FIG. 5 illustrates a case in which the wireless communication module 1400 is connected to the sanitization information storing unit 1120b, the inventive concept is not limited thereto. That is, according to an exemplary embodiment of the inventive concept, as shown in FIG. 4, the wireless communication module 1400 may be connected to the control unit 1140b, and receive a control signal CTRL from the control unit 1140b. The wireless communication module 1400 may transmit a wireless signal outside of the memory system 1000b in response to the control signal CTRL.

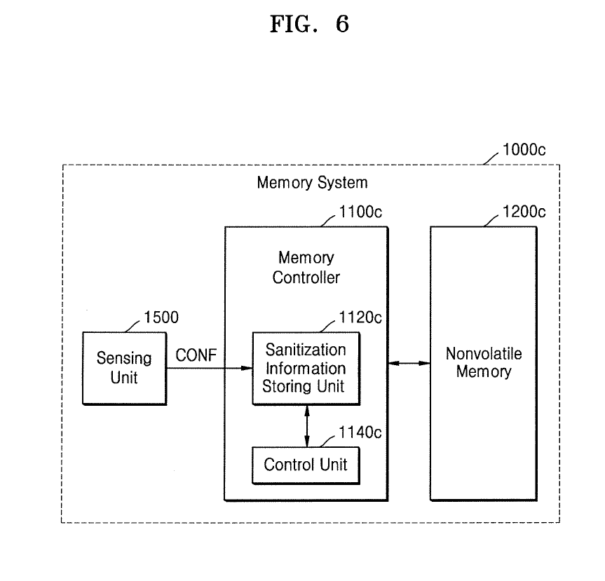

FIG. 6 is a diagram of a memory system 1000c including a sensing unit 1500 according to an exemplary embodiment of the inventive concept.

Similar to the memory system 1000 of FIG. 1, the memory system 1000e includes a memory controller 1100c and a non-volatile memory 1200c. The memory controller 1100c may control a non-volatile memory 1200c, and include a sanitization information storing unit 1120c and a control unit 1140c.

According to an exemplary embodiment of the inventive concept, the memory system 1000c includes a sensing unit 1500. The sensing unit 1500 may be connected to the sanitization information storing unit 1120c, and sense an invasive attack against the memory system 1000c. For example, the sensing unit 1500 may sense a physical or chemical attack, such as an attempt to dismantle or open a case of the memory system 1000c, and output a configuration signal CONF when the invasive attack is sensed. In an exemplary embodiment, the sensing unit 1500 includes or is connected to physical sensors located on panels of the case that are tripped when one of these panels is opened, so these physical sensors can alert the sensing unit 1500 of a potential invasive attack. In an exemplary embodiment, the sensing unit 1500 includes a motion sensor which detects motion. The sensing unit 1500 can analyze the detected motion to determine whether it corresponds to an invasive attack. In an exemplary embodiment, the sensing unit 1500 includes a chemical sensor that senses a current chemical property of a particular material within the case. The sensing unit 1500 can compare the current chemical property against a reference chemical property to determine whether it corresponds to an invasive attack. In an exemplary embodiment, the sensing unit 1500 is located within the memory controller 1100c.

As shown in FIG. 6, the sanitization information storing unit 1120c receives a configuration signal CONF, which is output by the sensing unit 1500 when the invasive attack is sensed. The sanitization information storing unit 1120c may be configured to output a signal corresponding to the second information or output a signal corresponding to third information other than the first information and the second information, in response to the received configuration signal CONF. For example, the third information may indicate that the memory 1200c was removed, replaced with a new memory, or indicate that an invasive attack occurred. That is, when the memory system 1000c senses an invasive attack in spite of previously performed data sanitization, first information stored in the sanitization information storing unit 1120c may not be valid. For example, an invader may replace the non-volatile memory 1200c mounted in the memory system 1000c with another non-volatile memory in which data requiring security is stored. Accordingly, when the invasive attack is sensed, the sanitization information storing unit 1120c may output a signal corresponding to the second information or the third information different from the first information and the second information, and informs a device outside of the memory system 1000c that the non-volatile memory 1200c may not be in a sanitization state. The third information may be stored in the sanitization information storing unit 1120c in a non-volatile manner.

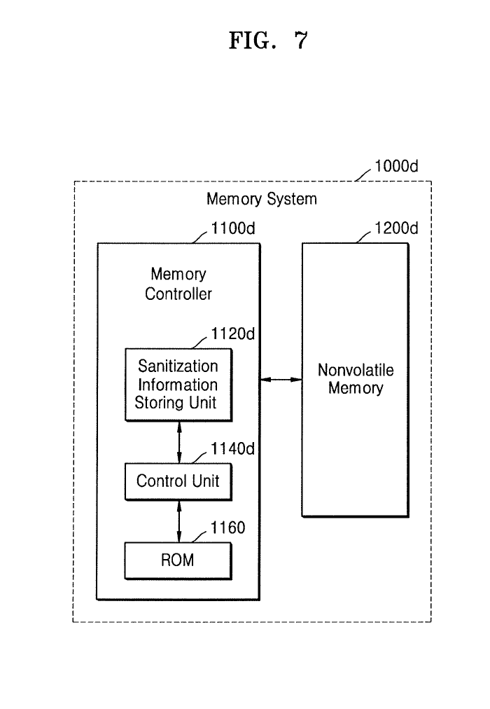

FIG. 7 is a diagram of a memory system 1000d including a memory controller 1100d according to exemplary embodiments of the inventive concept.

As shown in FIG. 7, the memory system 1000d includes a memory controller 1100d and a non-volatile memory 1200d. Similar to the embodiment of FIG. 1, the memory controller 1100d may include a sanitization information storing unit 1120d and a control unit 1140d.

According to an exemplary embodiment of the inventive concept, the control unit 1140d is a processor configured to execute instructions. The processor may execute a series of instructions and perform desired operations. Also, the processor may access a memory included in the processor or an external memory and receive instructions. In the present embodiment, the control unit 1140d may execute a plurality of instructions and access the sanitization information storing unit 1120d.

According to an exemplary embodiment of the inventive concept, the memory controller 1100d may include read-only memory (ROM) 1160, which is accessed by the control unit 1140d that is the processor. The ROM 1160 may be a memory incapable of changing stored data, and data may be written into the ROM 1160 during a manufacturing process or due to an irreversible program operation. The ROM 1160 may include a plurality of instructions related with an operation of, by the control unit 1140d, accessing the sanitization information storing unit 1120d. Thus, the control unit 1140d may execute a plurality of instructions stored in the ROM 1160 instead of a memory capable of being reprogrammed, and prevent an attempt to change an operation of accessing the sanitization information storing unit 1120d.

Although FIG. 7 illustrates an embodiment in which the control unit 1140d is the processor, the inventive concept is not limited thereto. That is, the control unit 1140 of FIG. 1 may be a digital circuit including a plurality of logic gates, and may access the sanitization information storing unit 1120 by using a state machine included therein, instead of performing instructions.

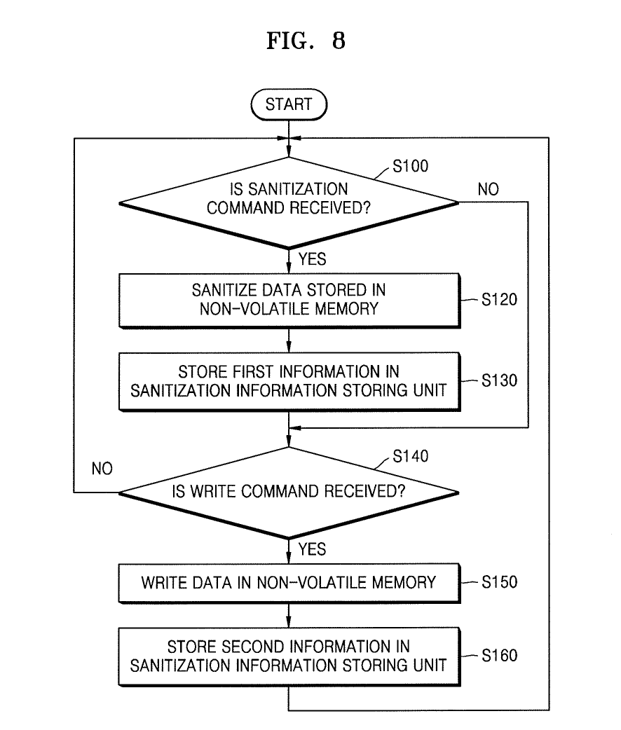

FIG. 8 is a flowchart illustrating a method of certifying data sanitization according to exemplary embodiments of the inventive concept.

Referring to FIGS. 1 and 8, the memory controller 1100 of the memory system 1000 determines whether a command received from the host 2000 is a sanitization command (S100). When the command received from the host 2000 is the sanitization command, the memory controller 1100 sanitizes data stored in the non-volatile memory 1200 (S120). When the sanitization of the data is completed, the memory controller 1100 (or the control unit 1140 and stores first information in the sanitization information storing unit 1120 (S130). The first information may indicate the non-volatile memory has been sanitized.

The memory controller 1100 of the memory system 1000 determines whether the command received from the host 2000 is a write command (S140). When the command received from the host 2000 is a write command, the memory controller 1100 writes data accompanying the write command, into the non-volatile memory 1200 (S150). When data is written into the non-volatile memory 1200, the memory controller 1100 (or the control unit 1140) stores second information in the sanitization information storing unit 1120 (S160). The second information may indicate that the memory has exited the sanitized state or is no longer sanitized.

According to an exemplary embodiment of the inventive concept, the control unit 1140 stores the first information in the sanitization information storing unit 1120 when the sanitization operation has completed, and stores the second information in the sanitization information storing unit 1120 when the write command is received from the host 2000. That is, according to an exemplary embodiment of the inventive concept, to increase reliability of information stored in the sanitization information storing unit 1120, the first information may be stored in the sanitization information storing unit 1120 at a time point in which the sanitization operation has completed, while the second information may be stored in the sanitization information storing unit 1120 at a time point in which the write command has been received from the host 2000.

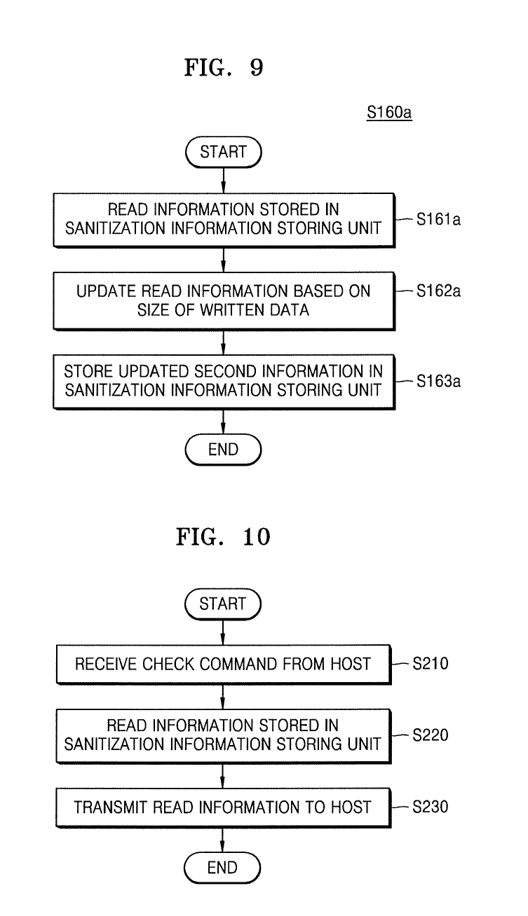

FIG. 9 is a flowchart illustrating an example S160a of an operation of storing second information shown in FIG. 8, according to an exemplary embodiment of the inventive concept. For example, step S160 of FIG. 8 may be implemented by the flow chart shown in FIG. 9.

Referring to FIGS. 1 and 9, the control unit 1140 reads information stored in the sanitization information storing unit 1120 (S161a). The control unit 1140 updates the read information based on the size of data written in response to the received write command (S162a). For example, when the information read from the sanitization information storing unit 1120 is first information, the control unit 1140 generates second information including information regarding the size of the information written in response to the received write command. Also, when the information read from the sanitization information storing unit 1120 is the second information, the control unit 1140 may obtain the size of data stored in the non-volatile memory 1200 before the write command is received, and accumulate the size of the data written in response to the received write command, in the obtained information. Next, the control unit 1140 stores the second information in the sanitization information storing unit 1120 (S163a).

FIG. 10 is a flowchart illustrating a method of transmitting information regarding sanitization of data from a memory system 1000 to a host 2000 according to an exemplary embodiment of the inventive concept memory system.

Referring to FIGS. 1 and 10, the memory controller 1100 of the memory system 1000 receives a check command from the host 2000 (S210). In response to the received check command, the memory controller 1100 (or the control unit 1140) reads information stored in the sanitization information storing unit 1120 (S220). The memory controller 1100 (or the control unit 1140) transmits a response including read information or data based on the read information to the host 2000 (S230).

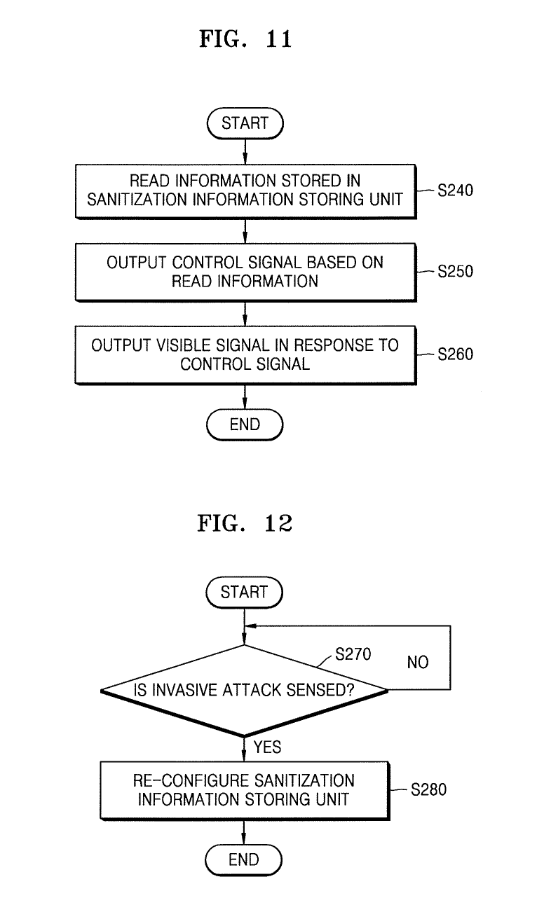

FIG. 11 is a flowchart illustrating an operation of the memory system 1000a of FIG. 4, according to an exemplary embodiment of the inventive concept FIG. 4.

Referring to FIGS. 4 and 11, the control unit 1140a reads information stored in the sanitization information storing unit 1120a (S240). The control unit 1140a outputs a control signal CTRL based on the read information (S250). The control signal CTRL may be transmitted to the indicator 1300, and the indicator 1300, which has received the control signal CTRL outputs a visible signal based on the received control signal CTRL (S260).

FIG. 12 is a flowchart illustrating an operation of the sensing unit 1500 of FIG. 6, according to an exemplary embodiment of the inventive concept.

Referring to FIGS. 6 and 12, the sensing unit 1500 senses an invasive attack against the memory system 1000c (S270). When the invasive attack is sensed, the sensing unit 1500 re-configures the sanitization information storing unit 1120c (S280). That is, the sensing unit 1500 may output a configuration signal CONF and configure the sanitization information storing unit 1120c so that the sanitization information storing unit 1120c outputs a signal corresponding to second information or outputs a signal corresponding to third information that is different from the first information and the second information. For example, the configuration signal CONF may change a physical state of a device connected to an output signal line of the sanitization information storing unit 1120c, and force an output signal of the sanitization information storing unit 1120c into a specific state. For example, if the non-volatile memory was previously sanitized, and replaced with a new memory, the information storing unit 1120c may continue to indicate that the new memory is also sanitized unless the information storing unit 1120c is re-configured.

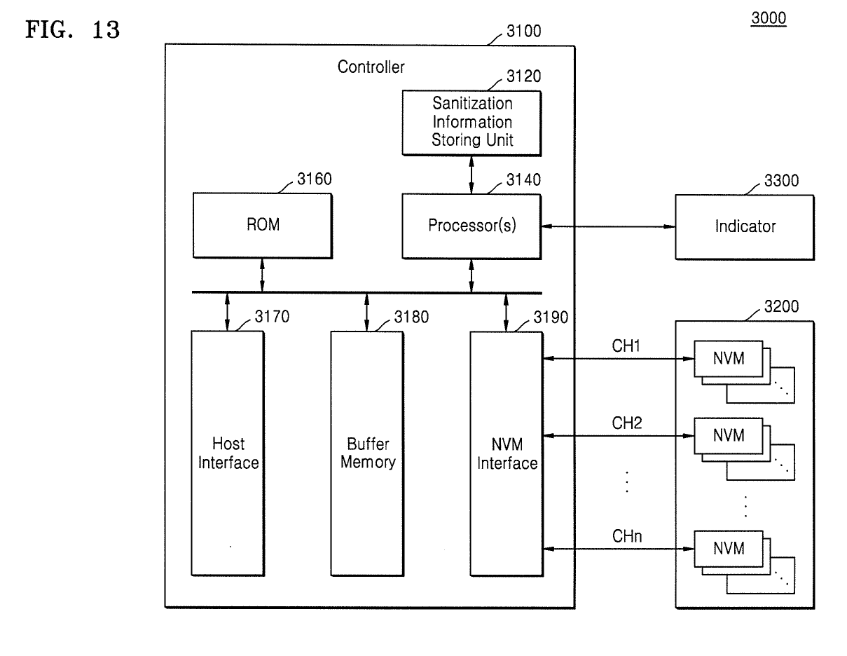

FIG. 13 is a diagram of a solid-state drive (SSD) 3000 according to exemplary embodiments of the inventive concept.

As shown in FIG. 13, the SSD 3000 includes a plurality of non-volatile memory devices 3200, a controller 3100 connected to the non-volatile memory devices 3200 through a plurality of channels CH1 to CHn, and an indicator 3300. The controller 3100 may perform operations as described above according to the exemplary embodiments of the inventive concept. For example, the controller 3100 may sanitize data stored in the non-volatile memory devices 3200 in response to a data sanitization command transmitted from a host, and include a sanitization information storing unit 3120 and at least one processor 3140 corresponding to the control unit 1140 of FIG. 1.

As shown in FIG. 13, the controller 3100 may include at least one processor 3140, a ROM 3160, a buffer memory 3180, a host interface 3170, and a non-volatile memory interface 3190, each of which may be connected to a bus. The buffer memory 3180 may store data required for operations of the controller 3100. For example, the buffer memory 3180 may store a mapping table configured to store mapping information between a logical address and a physical address. The ROM 3160 may store a plurality of instructions that are executed by the at least one processor 3140. The host interface 3170 may function to interface with an external host of the SSD 3000. The non-volatile memory interface 3190 may function to interface with the non-volatile memory device 3200.

The indicator 3300 may output a visible signal indicating whether the non-volatile memory device 3200 is in a sanitization state, to the outside of the SSD 3000 in response to a signal received from the memory controller 3100. Although FIG. 13 illustrates an embodiment in which the indicator 3300 is connected to the at least one processor 3140, the inventive concept is not limited thereto. That is, the indicator 3300 may receive a signal from the sanitization information storing unit 3120.

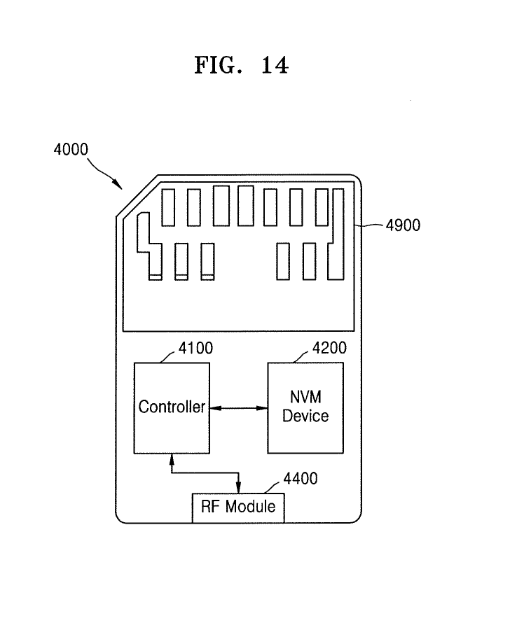

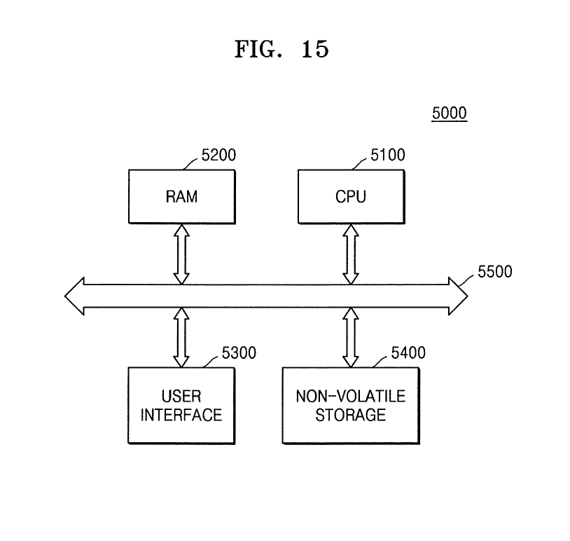

FIG. 14 is a diagram of a memory card 4000 according to exemplary embodiments of the inventive concept.

The memory card 4000 is an example of a portable storage device that may be connected to an electronic device, such as a mobile device (e.g., Smart Phone, Tablet computer, etc.) or a desk-top computer. The memory card 4000 may communicate with a host using various card protocols (e.g., unique factorization domain (UFD), multimedia card (MMC), secure digital (SD), mini-SD, or Micro-SD).

As shown in FIG. 14, the memory card 4000 includes a controller 4100, a non-volatile memory device 4200, an RF module 4400, and a port region 4900. The controller 4100 may perform operations of a memory controller, which are described above according to the exemplary embodiments of the inventive concept. For example, the controller 4100 may receive a data sanitization command from an external host through the port region 4900, and sanitize data stored in the non-volatile memory device 4200. Also, the controller 4100 may include a sanitization information storing unit, which stores information indicating whether the non-volatile memory device 4200 is in a sanitization state.

As shown in FIG. 14, the memory card 4000 may include the RF module 4400. The RF module 4400 may receive a signal based on information stored in the sanitization information storing unit included in the controller 4100, from the controller 4100. The

RF module 4400 may transmit a wireless signal to an RF terminal disposed outside the memory card 4000, based on the signal received from the controller 4100, and inform a device outside of the memory card of whether the non-volatile memory device 4200 of the memory card 4000 is in the sanitization state.

FIG. 15 is a diagram of a computing system 5000 including a non-volatile storage 5400 according to an exemplary embodiment of the inventive concept non-volatile storage.

A memory system according to an exemplary embodiment of the inventive concept may be mounted as the non-volatile storage 5400 in the computing system 5000, such as a mobile device or a desk-top computer. The memory system, which is mounted as the non-volatile storage 5400, may include a memory controller and a non-volatile memory, which are described above according to exemplary embodiments of the inventive concept. For example, the memory controller may receive a data sanitization command from a host disposed outside the non-volatile storage, and sanitize data stored in the non-volatile memory. Also, the memory controller may include a sanitization information storing unit, which stores information indicating whether the non-volatile memory is in a sanitization state.

The computing system 5000 according to an exemplary embodiment of the inventive concept includes a central processing unit (CPU) 5100, a RAM 5200, a user interface 5300, and a non-volatile storage 5400, each of which may be connected to a bus 5500. The CPU 5100 may generally control the computing system 5000. For example, the CPU 5100 may be an application processor (AP). The RAM 5200 may function as a data memory of the CPU 5100, and be integrated with the CPU 5100 into a single chip using a System-on-Chip (SoC) technique or a Package-on-Package (PoP) technique. The user interface 5300 may receive input signals from a user or output signals to the user via images and/or voices. The user interface 5300 may be used by a user to send a command to sanitize the non-volatile storage 5400 or to send a command to query on the sanitization state of the non-volatile storage 5400.

While the inventive concept has been particularly shown and described with reference to exemplary embodiments thereof, it will be understood that various changes in form and details may be made therein without departing from the spirit and scope of the inventive concept.

What is claimed is:

1. A memory controller comprising:
a sanitization information storing unit configured to store first information or second information in a non-volatile manner; and
a control unit configured to store the first information in the sanitization information storing unit when sanitization of data stored in a non-volatile memory has completed in response to a sanitization command of a host and store the second information in the sanitization information storing unit in response to a write command of the host.

2. The memory controller of claim 1, wherein the control unit reads information stored in the sanitization information storing unit in response to a check command of the host and transmits the read information to the host.

3. The memory controller of claim 1, wherein the control unit reads information stored in the sanitization information storing unit and outputs a control signal based on the read information.

4. The memory controller of claim 1, wherein the control unit is a processor configured to execute a plurality of instructions and access the sanitization information storing unit, and
the memory controller further comprises read-only memory (ROM) that stores the plurality of instructions and is accessed by the processor.

5. The memory controller of claim 1, wherein the first information includes information regarding types of the sanitization of the data.

6. The memory controller of claim 5, wherein the types of the sanitization of the data comprises a Secure Erase or a Crypto Erase.

7. The memory controller of claim 1, wherein the second information includes information regarding the size of data stored in the non-volatile memory in response to at least one write command of the host.

8. A memory system comprising:
a non-volatile memory; and
a memory controller configured to control the non-volatile memory,
wherein the memory controller comprises:
a sanitization information storing unit configured to store first information or second information in a non-volatile manner; and
a control unit configured to store the first information in the sanitization information storing unit when sanitization of data stored in the non-volatile memory has completed in response to a sanitization command of a host and store the second information in the sanitization information storing unit in response to a write command of the host.

9. The memory system of claim 8, wherein the control unit reads information stored in the sanitization information storing unit in response to a check command of the host and transmits the read information to the host.

10. The memory system of claim 8, wherein the control unit reads information stored in the sanitization information storing unit and outputs a control signal based on the read information, and
the memory system further comprises an indicator configured to output a visible signal based on the control signal.

11. The memory system of claim 10, wherein the indicator comprises a light-emitting diode (LED) or an electronic ink (e-ink) panel.

12. The memory system of claim 8, further comprising a wireless communication module connected to the sanitization information storing unit,
wherein the wireless communication module outputs a wireless signal based on information stored in the sanitization information storing unit.

13. The memory system of claim 8, further comprising a sensing unit connected to the sanitization information storing unit and configured to sense an invasive attack against the memory system,
wherein the sanitization information storing unit is re-configured to output a signal corresponding to the second information or third information that is different from the first information and the second information when the sensing unit senses the invasive attack.

14. The memory system of claim 8, wherein the non-volatile memory comprises a plurality of flash memory devices each of which includes a three-dimensional memory array.

15. The memory system of claim 14, wherein the three-dimensional memory array comprises a portion that is monolithically formed in one or more physical levels of memory cells having active areas disposed above a silicon substrate.

16. A memory system comprising:
a non-volatile memory;
a memory controller; and
a sensing unit configured to output a message to the memory controller when the sensing unit senses a physical attack against the memory system,
wherein the memory controller is configured to sanitize data stored within the non-volatile memory and store information within the memory controller indicating the data has been sanitized, in response to a command received from a host, and
wherein the memory controller is configured to update the information to indicate the data has not been sanitized in response to receipt of the message.

17. The memory system of claim 16, wherein the sensing unit is configured to sense whether an attempt to dismantle a case of the memory system has occurred.

18. The memory system of claim 16, wherein the memory controller is configured to update the information to indicate the data has not been sanitized after receiving a command from the host to write data into the non-volatile memory.

19. The memory system of claim 16, further comprising an electronic ink panel or a light emitting diode to visibly indicate whether the data has been sanitized.

20. The memory system of claim 16, wherein the memory controller sanitizes the data by performing one of a Clear or a Purge action on the non-volatile memory.
